(19) United States
(12) Patent Application Publication
(10) Pub. No.: US 2006/0023981 A1
(43) Pub. Date: Feb. 2, 2006

(54) GAS DYNAMIC PRESSURE BEARING, MOTOR HAVING THE GAS DYNAMIC PRESSURE BEARING, AND DISK DRIVE HAVING THE MOTOR

(75) Inventor: Yoshiki Okayama, Kyoto (JP)

Correspondence Address: JUDGE PATENT FIRM;RIVIERE SHUKUGAWA 3RD FL., 3-1 WAKAMATSU-CHO, NISHINOMIYA-SHI, HYOGO, 662-0035, JP

(73) Assignee: Nidec Corporation, Kyoto (JP)

(21) Appl. No.: 10/710,661

(22) Filed: Jul. 27, 2004

(51) Int. Cl. F16C 32/06

(52) U.S. Cl. 384/100

(57) ABSTRACT

A gas dynamic pressure bearing comprises a shaft, a sleeve whose inner peripheral surface is opposed to an outer peripheral surface of the shaft through a micro-gap, and a substantially cylindrical hub which applies a surface pressure to an outer side of the sleeve and which is fitted to the sleeve, and at least one of the outer peripheral surface of the shaft and the inner peripheral surface of the sleeve is formed with a dynamic pressure generating groove, and if linear expansion coefficients of the shaft, the sleeve and the hub are defined as a₀, a₁ and a₂, respectively, a relation of a₁<α₀<α₂ is satisfied.

### BACKGROUND OF INVENTION

1. Technical Field

The present invention relates to a gas dynamic pressure bearing, a motor having the gas dynamic pressure bearing, and a disk drive having the motor. The present invention is utilized in a motor which rotates a magnetic disk such as a hard disk and a DVD, a disk apparatus and a laser printer having the motor.

2. Description of the Related Art

A motor which rotates a magnetic disk such as a hard disk is required to rotate at high speed and with high precision. As bearing means of the motor which rotates the magnetic disk, a fluid dynamic pressure bearing capable of stably rotating is becoming pervasive. Generally, the fluid dynamic pressure bearing comprises two members, first and second members. The first member is a columnar shaft, and one or two disk-like thrust plates are disposed on one or both ends of the shaft. The second member is opposed to an outer peripheral surface of the shaft through a radial gap and to one or two flat surfaces of the thrust plates through thrust gaps. At least one of both surfaces confronting these gaps on the members (a set of the surfaces and the gap is referred to as “a bearing surface”, hereinafter) has a dynamic pressure generating groove having a herringbone-like or spiral shape, and lubricating fluid such as air or oil exists in these gaps. If one of the first and second members rotates with respect to the other member, the lubricating fluid increases the fluid pressure in the radial gap and the thrust gap by the pumping effect of the dynamic pressure generating groove. With this, rotating sides of the first and second members float up with respect to the stationary sides thereof, and a non-contact state between the first and second members is maintained during the rotation.

In the gas dynamic pressure bearing, a gas is used as the lubricating fluid. Unlike a liquid dynamic pressure bearing using oil as the lubricating fluid, the gas dynamic pressure bearing does not have a leakage problem of the lubricating fluid. However, a viscosity resistance value of gas is extremely small as compared with oil. Thus, as compared with the oil dynamic pressure bearing, this gas dynamic pressure bearing employs a structure that the speed of the rotating side in the bearing surface is increased and the bearing gap is set smaller than that of the oil dynamic pressure bearing. With this structure, a sufficient rotation supporting force is generated in the gas bearing. Generally, in the oil dynamic pressure bearing, the bearing gap is 2 to 5 μm, but in the gas dynamic pressure bearing, the bearing gap is 2 μm or less. In the case of the gas dynamic pressure bearing, since the bearing gap is small, 1) when the bearing gap is narrowed due to the temperature rise, i.e., when the thermal expansion coefficient of the shaft is greater than that of a sleeve, the bearing gap is eliminated and the bearing surface comes into contact, and a rotation-inability state so-called locked state is generated. Further, 2) when the bearing gap becomes wide due to the temperature rise, i.e., when the thermal expansion coefficient of the shaft is smaller than that of the sleeve, the rotation supporting force becomes insufficient, and the rotation precision is deteriorated. Various prior arts have been made so as to prevent the bearing gap from being changed. According to one of the prior arts, copper alloy is used as material of the sleeve, austenitic stainless steel is used as material of the shaft, and the values of the thermal expansion coefficients of both the materials are substantially identical each other. According to another prior art, the bearing surfaces confronting the thrust gap are made of different material each other. When one material is a stainless metal, the other material is ceramic such as zirconia. With this prior art, one material is selected so as to have substantially the same value of its thermal expansion coefficient as that of the other material, and a wearing amount caused by a friction between the shaft or the thrust plate and the sleeve is reduced.

### SUMMARY OF INVENTION

However, in any of the related prior arts materials of the stationary side and the rotating side are selected to be substantially identical each other. Since the materials must be selected from such a range, the combination of the materials may not be optimized in terms of other aspects such as workability, price and lubricity.

It is an object of the present invention to widen a choice of the materials of the stationary side and the rotating side.

It is also possible to reduce the change of size of the gap which may be caused by a temperature change.

According to one example of the gas dynamic pressure bearing of the present invention, the bearing comprises a shaft, a sleeve whose inner peripheral surface is opposed to an outer peripheral surface of the shaft through a micro-gap, and a substantially cylindrical hub which applies a surface pressure to an outer side of the sleeve and which is fitted to the sleeve, and a dynamic pressure generating groove is formed on at least one of the outer peripheral surface of the shaft and the inner peripheral surface of the sleeve, and if linear expansion coefficients of the shaft, the sleeve and the hub are defined as α₀, α₁ and α₂, respectively, a relation of α₁<α₀<α₂ is satisfied.

In this gas dynamic pressure bearing, when the temperature is 20° C., the sleeve is fitted to the hub and the sleeve is compressed toward the inner diameter side and fixed. If the temperature rises, the radial gap between the shaft and the sleeve tends to be narrow from the relation of α₁<α₀. This variation amount of the gap is defined as A. The fastening width between the sleeve and the hub is reduced from the relation of α₁<α₂ and thus, the surface pressure between the sleeve and the hub is moderated, and the sleeve tries to expand in radial direction. This expansion causes the radial gap between the shaft and the sleeve to be wide. The expansion amount is defined as B. As a result, the expansion amount B cancels the gap variation amount A each other, and the actual variation in radial gap caused by the temperature rises is reduced or suppressed. Further, since the above inequality is satisfied, the optimal material can be applied to various members in terms of workability, price and lubricity.

It is preferable that if a fastening width between the sleeve and the hub at 20° C. is defined as δ, and a fitting diameter between the sleeve and the hub is defined as 2R₂ and a difference between the maximum using temperature and 20° C. is defined as ΔT, the following relation expression (1) is satisfied, and if a thickness of the sleeve is defined as t₁ and a thickness of the hub is defined as t₂, the following relation expression (2) is satisfied:
2R₂ΔT(α₂−α₁)≦δ (1)
t₂/t₁≧0.25 (2).

If the relation expression (1) is satisfied, the fastening width can be secured, in spite of the sleeve expanding in the using temperature range of the gas dynamic pressure bearing. In this case, however, if the thickness of the hub is excessively thin as compared with that of the sleeve, only the hub is deformed in the expansion direction when a shrinkage fitting or a press fitting is applied for fixing the hub, and a predetermined surface pressure is not applied to the sleeve. This is the reason why the relation expression (2) is set. With this, when the sleeve and the hub are fitted to each other with the fastening width which satisfies the relation expression (1), the predetermined surface pressure is applied therebetween. As a result, the variation of the radial gap is reduced and the looseness of the fitted portion is prevented.

The variation amount of the radial gap when the shaft, the sleeve and the hub are made of materials which satisfy the above conditions can be obtained by the following equation:

First, the outer diameter of the shaft, the inner diameter of the sleeve, the fitting diameter between the sleeve and the hub, and the outer diameter of the hub are defined as 2R₀, 2R₁, 2R₂ and 2R₃, respectively. The moduli of longitudinal elasticity of the sleeve material and the hub material are defined as E₁ and E₂, and the Poisson's ratios of the sleeve material and the hub material are defined as _{ν1} and ν₂. The surface pressure Pm generated in the fastened surfaces between the hub and the sleeve by the press fitting or shrinkage fitting can be expressed by the following equation (3).

$$Pm = δ / \{ 2 {R}_{2} ( \frac{{R}_{2}^{2} + {R}_{1}^{2}}{{E}_{1} ( {R}_{2}^{2} - {R}_{1}^{2} )} + \frac{{R}_{3}^{2} + {R}_{2}^{2}}{{E}_{2} ( {R}_{3}^{2} - {R}_{2}^{2} )} - \frac{{v}_{1}}{{E}_{1}} + \frac{{v}_{2}}{{E}_{2}} ) \} \qquad ( 3 )$$

The inner diameter of the sleeve is shrunk by u expressed in the following equation (4) by Pm.

$$u = - \frac{2 {R}_{1}^{2} {R}_{2}^{2} Pm}{{E}_{1} ( {R}_{2}^{2} - {R}_{1}^{2} ) {R}_{1}} \qquad ( 4 )$$

Therefore, the radial gap Cr at the normal temperature becomes
Cr=R₁−R₀−u (5).

Next, if the temperature rises by ΔT, the surface pressure Pm and the shrinking amount of the inner diameter of the sleeve are obtained by the following equations (6) and (8).

$$\begin{matrix}{Pm}^{′} = {δ}^{′} / \{ 2 {R}_{2}^{′} ( \frac{{R}_{2}^{′2} + {R}_{1}^{′2}}{{E}_{1} ( {R}_{2}^{′2} - {R}_{1}^{′2} )} + \frac{{R}_{3}^{′2} + {R}_{2}^{′2}}{{E}_{2} ( {R}_{3}^{′2} - {R}_{2}^{′2} )} - \frac{{v}_{1}}{{E}_{1}} + \frac{{v}_{2}}{{E}_{2}} ) \} & ( 6 ) \\ \begin{matrix}{R}_{0}^{′} = {R}_{0} ( 1 + {α}_{0} Δ T ) \\ {R}_{1}^{′} = {R}_{1} ( 1 + {α}_{1} Δ T ) \\ {R}_{2}^{′} = {R}_{2} ( 1 + {α}_{1} Δ T ) \\ {R}_{3}^{′} = {R}_{3} ( 1 + {α}_{2} Δ T ) \\ … \\ {δ}^{′} = 2 {R}_{2} ( {α}_{1} - {α}_{2} ) Δ T + δ\end{matrix} \} & ( 7 ) \\ {u}^{′} = - \frac{2 {R}_{1}^{′2} {R}_{2}^{′2} {Pm}^{′}}{{E}_{1} ( {R}_{2}^{′2} - {R}_{1}^{′2} ) {R}_{1}^{′}} & ( 8 )\end{matrix}$$

The radial gap Cr′ after the temperature rise is expressed by the following equation (9):
Cr′=R1′−R₀′−u′=(R₁α₁−R₀α₀)ΔT−u′ (9).

Therefore, the variation amount of the radial gap is obtained by the following equation:
Cr−Cr′=R₁−R₀−u−(R₁α₁−R₀α₀)ΔT+u′ (10)

In this regard u′ is a value determined by substituting the equation group (7) into the equations (6) and (8).

Since the gas dynamic pressure bearing of the invention have the above described effect, the motor having the gas dynamic pressure bearing, the bracket for fixing the shaft, the stator mounted on the bracket and the magnet mounted on the hub such as to be opposed to the stator operates stably.

According to the present invention, the variation amount of the radial gap is reduced only by setting the linear expansion coefficients of the members in the vicinity of the bearing surface to the predetermined inequality relations. Since the surface pressure of the fitted portions between the sleeve and the hub can be secured, the choice of the members can be widened. This is advantageous for various devices to which the gas dynamic pressure bearing is applied.

### BRIEF DESCRIPTION OF DRAWINGS

FIG. 1 is a schematic sectional view of a hard disk drive according to an embodiment taken along an axial direction of rotation; and

FIG. 2 is a sectional view of a motor used in the hard disk drive taken along the axial direction.

### DETAILED DESCRIPTION

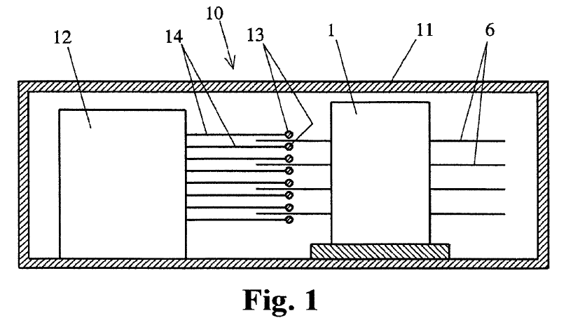

An embodiment of the present invention will be explained with reference to the drawings. FIG. 1 is a schematic sectional view of a hard disk drive according to an embodiment taken along an axial direction of rotation (axial direction, hereinafter). A hard disk drive 10 includes a housing 11 whose interior is kept clean, a dynamic pressure bearing motor (motor, hereinafter) 1 disposed in the housing 11, and an actuator 12. A plurality of (four in the drawing) magnetic disks 6 are mounted on the motor 1 in the axial direction. If the motor 1 is driven, the magnetic disks 6 rotate in a predetermined direction. Arms 14 having magnetic heads 13 are mounted on the actuator 12 with respect to the magnetic disks 6 such that the arms 14 extend in the radial direction. When the hard disk drive 10 is not used, the magnetic heads 13 are retreated together with the arms 14 to positions away from the magnetic disks 6, and if the motor 1 is driven, the magnetic heads 13 are turned by the operation of the actuator 12 and the magnetic heads 13 come close to the magnetic disks 6 to read/write information.

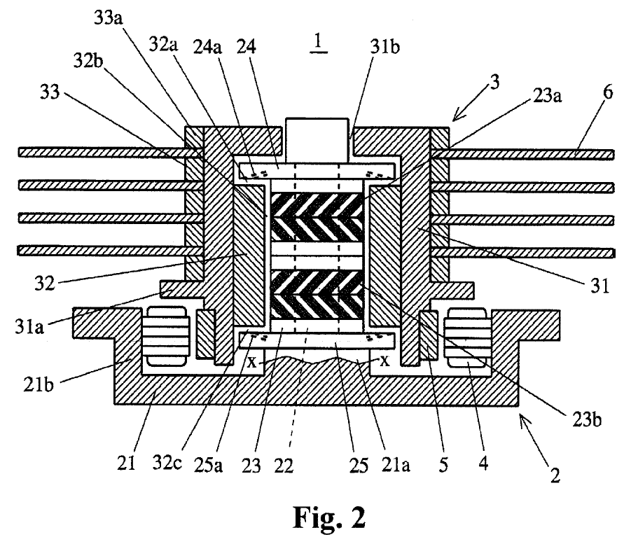

FIG. 2 is a sectional view showing the motor 1 used in the hard disk drive 10 taken along the axial direction. FIG. 2 is a partially front view taken along the braking line X-X. The motor 1 includes a stationary member 2 fixed to an inner surface of the housing 11, a rotation member 3 supported through a later-described gas dynamic pressure bearing such that the rotation member 3 can rotate with respect to the stationary member 2, a stator 4 and a magnet 5.

The stationary member 2 comprises a substantially recessed disk-like bracket 21, an inner shaft 22, an outer shaft 23, an upper thrust plate 24 and a lower thrust plate 25. A through hole (not shown) is formed at its central portion of the bracket 21, and a peripheral edge of the through hole is made thick to form a boss 21a. The bracket 21 is provided at its peripheral edge with a cylindrical wall 21b. The stator 4 is mounted on an inner surface of the wall 21b. A current is supplied to a coil of the stator 4 from an external power supply through a flexible circuit substrate (not shown) provided at a predetermined portion of the bracket 21. The inner shaft 22 is columnar in shape, and its lower end is fitted into the through hole and is supported by the boss 21a. The outer shaft 23 is cylindrical in shape. The outer shaft 23 is fitted over the outer periphery of the inner shaft 22 exposed from the boss 21a. The lower thrust plate 25 overhangs from the outer shaft 23 in the radial direction. The lower thrust plate 25 is fitted into the inner shaft 22 such that the lower thrust plate 25 is sandwiched between the lower end surface of the outer shaft 23 and the boss 21a. The upper thrust plate 24 also overhangs from the outer shaft 23 in the radial direction, and in contact with an upper end surface of the outer shaft 23 and fitted into the inner shaft 22.

The rotation member 3 includes a substantially cylindrical hub 31. The hub 31 is formed at its upper end close with a through hole 31b. The rotation member 3 also comprises a cylindrical sleeve 32 which is shrinkage fitted into the inner peripheral surface of the hub 31. The rotation member 3 also includes a damper 33a and a plurality of (four in the drawing) spacers 33. Upper and lower end surfaces of the sleeve 32 are sandwiched between the upper and lower thrust plates 24 and 25 through micro-gaps (thrust gap, hereinafter) 32a and 32c such that the upper and lower end surface are opposed to the upper and lower thrust plates 24 and 25, respectively. An inner peripheral surface of the sleeve 32 is opposed to an outer peripheral surface of the outer shaft 23 through a micro-gap (radial gap, hereinafter) 32b. An inner peripheral surface of the hub 31 exposed from upper end lower portions of the sleeve 32 surrounds the upper and lower thrust plates 24 and 25 and the boss 21a. The hub 31 includes a flange 31a on its outer peripheral surface to its lower endvicinity. An outer peripheral surface of the hub 31 lower than the flange 31a holds the magnet 5. A portion of the hub 31 higher than the flange 31a has uniform outer diameter. An upper end of the inner shaft 22 passes through the through hole 31 band is exposed outside of the hub 31. The magnet 5 is opposed to the stator 4. The spacers 33 protrude from the flange 31a of the hub 31 toward the higher outer peripheral surface to determine the distance between the magnetic disks 6 in the axial direction. The damper 33a is fixing means for fixing the plurality (four in the drawing) ofmagnetic disks 6 and the spacers 33 to the hub 31.

The lower surface of the upper thrust plate 24 and the upper surface of the lower thrust plate 25 are formed with a large number of grooves 24a and 25a which are curved from inside toward outside in a form of an arc. The grooves 24a and 25a have depth of some pm and arranged at equal distances from one another in the radial direction. When the rotation member 3 rotates, the grooves 24a and 25a generate the pumping effect which inwardly sends air existing in the thrust gap 32a. With this, the dynamic pressure of the thrust gaps 32a and 32c is generated, and the non-contact state between thestationary member 2 and the rotation member 3 in the axial direction is maintained. An upper half and a lower half of the outer peripheral surface of the outer shaft 23 are formed with a large number of L-shaped grooves 23a and 23b having depth of some μm. The grooves 23a and 23b are arranged at equal distances from one another in the radial direction. The grooves 23a and 23b generate the pumping effect for sending air existing in the radial gap 32b toward the folded-back point of each groove when the rotation member 3 rotates. With this, the dynamic pressure of the radial gap 32b is generated, and the non-contact state between the stationary member 2 and the rotation member 3 in the radial direction is maintained. As described above, the portions constituting the thrust gaps 32a and 32c and the radial gap 32b function as the dynamic pressure gas bearing.

Next, the operation of the motor 1 will be explained.

If current is supplied to the coil of the stator 4, magnetic force is generated between the stator 4 and the magnet 5, and the hub 31 starts rotating together with the sleeve 32 by this magnetic force. Then, the dynamic pressure is generated in the thrust gaps 32a and 32c and the radial gap 32b as described above, and the rotation member 3 keeps rotating while maintaining the non-contact state with respect to the stationary member 2.

As the rotation member 3 rotates, the stationary member 2 and the rotation member 3 try to expand in accordance with the thermal expansion coefficients thereof due to the head from the coil caused by the current supply or a temperature rise of the environment temperature. In this embodiment, the outer shaft 23 is made of Al₂O₃—TiC ceramic having the thermal expansion coefficient ((α₀=6.2×10⁻⁶/° C.). The sleeve 32 is made of Al₂O₃ having the thermal expansion coefficient (α₁=5.1×10⁻⁶/° C.). The hub 31 is made of ferrite stainless steel having the thermal expansion coefficient (α₂=10.1×10⁻⁶/° C.). An outer diameter 2R₀ of a portion of the outer shaft 23 which is opposed to the sleeve 32 is set to 9.994 mm, an inner diameter 2R₁ of the sleeve 32 is set to 10 mm, and a fitting diameter 2R₂ between the sleeve 32 and the hub 31 is set to 17.5 mm. An outer diameter 2R₃ of a portion of the hub 31 higher than the flange 31a is set to 20 mm, and a fastening width δ of the fitting portion between the hub 31 and the sleeve 32 is set to 10 μm. Under the above conditions, variation amounts of the radial gap in the radial direction when the temperature was 20° C. and when the temperature was 80° C. were obtained in accordance with the above equation (10), and a result thereof was 0.02 μm or lower. A value of the left side of the equation (1) was obtained and a result thereof was 5.25 μm. A ratio t₂/t₁ of a thickness t₂ of the hub 31 and a thickness t₁ of the sleeve 32 was 0.33, which satisfied the equations (1) and (2), and a necessary surface pressure was applied to the fitting portion.

As comparison, if the same materials were used for both the sleeve 32 and the outer shaft 23, the variation amount of the radial gap in the radial direction was 0.3 μm.

While single embodiments in accordance with the present invention of various sizes, properties, a dynamic pressure bearing, a motor and a disk drive have been explained in the foregoing, the present invention is not limited to such embodiments. Various changes and modifications are possible without departing from the scope of the invention.

1. A gas dynamic pressure bearing comprising:
a shaft,
a sleeve whose inner peripheral surface is opposed to an outer peripheral surface of the shaft through a micro-gap, and
a substantially cylindrical hub which applies a surface pressure to an outer side of the sleeve and which is fitted to the sleeve, in which
a dynamic pressure generating groove is formed on at least one of the outer peripheral surface of the shaft and the inner peripheral surface of the sleeve, wherein
if linear expansion coefficients of the shaft, the sleeve and the hub are defined as α₀, α₁ and α₂, respectively, a relation of α₁<α₀<α₂ is satisfied.

2. The gas dynamic pressure bearing as set forth in claim 1, wherein
if a fastening width between the sleeve and the hub at 20° C. is defined as δ, and a fitting diameter between the sleeve and the hub is defined as 2R₂ and a difference between the maximum using temperature and 20° C. is defined as ΔT, the following relation expression (1) is satisfied, and
if a thickness of the sleeve is defined as t₁ and a thickness of the hub is defined as t₂, the following relation expression (2) is satisfied:
2R₂ΔT((α₂−α₁)≦δ (1)
t₂/t₁≧0.25 (2).

3. A motor having a gas dynamic pressure bearing, comprises:
a shaft,
a sleeve whose inner peripheral surface is opposed to an outer peripheral surface of the shaft through a micro-gap, and
a substantially cylindrical hub which applies a surface pressure to an outer side of the sleeve and which is fitted to the sleeve, in which
a dynamic pressure generating groove is formed on at least one of the outer peripheral surface of the shaft and the inner peripheral surface of the sleeve, wherein
if linear expansion coefficients of the shaft, the sleeve and the hub are defined as α₀, α₁ and α₂, respectively, a relation of α₁<α₀<α₂ is satisfied, and
the motor further comprises a bracket for fixing the shaft, a stator mounted on the bracket, and a magnet mounted on the hub such as to be opposed to the stator.

4. The motor as set forth in claim 3, wherein in the gas dynamic pressure bearing,
if a fastening width between the sleeve and the hub at 20° C. is defined as δ, and a fitting diameter between the sleeve and the hub is defined as 2R₂ and a difference between the maximum using temperature and 20° C. is defined as ΔT, the following relation expression (1) is satisfied, and
if a thickness of the sleeve is defined as t₁ and a thickness of the hub is defined as t₂, the following relation expression (2) is satisfied:
2R₂ΔT((α₂−α₁)≦δ 1)
t₂/t₁≧0.25 (2).

5. A disk apparatus on which a disk-like storage medium capable of storing information is mounted, the disk apparatus comprising;
a housing,
a motor for spinning the recording disk and fixed inside said housing,
and a data access means for reading/writing data on the recording disks, wherein
the motor comprises a shaft, a sleeve opposed whose inner peripheral surface is opposed to an outer peripheral surface of the shaft through a micro-gap, and a sub-stantially cylindrical hub which is fitted when a surface pressure is applied to an outer side of the sleeve, the motor further comprises a gas dynamic pressure bearing in which a dynamic pressure generating groove is formed on at least one of the outer peripheral surface of the shaft and the inner peripheral surface of the sleeve,
if linear expansion coefficients of the shaft, the sleeve and the hub are defined as α₀, α₁ and α₂, respectively, a relation of α₁<α₀<α₂ is satisfied,
the motor further comprises a bracket for fixing the shaft, a stator mounted on the bracket, and a magnet mounted on the hub such as to be opposed to the stator.

6. A hard disk drive as set forth in claim 5, wherein in the gas dynamic pressure bearing,
if a fastening width between the sleeve and the hub is defined as δ, and a fitting diameter between the sleeve and the hub is defined as 2R₂ and a difference between the maximum using temperature and 20° C. is defined as T, the following relation expression (1) is satisfied, and
if a thickness of the sleeve is defined as t₁ and a thickness of the hub is defined as t₂, the following relation expression (2) is satisfied:
2R₂ΔT((α₂−α₁)≦δ (1)
t₂/t₁≧0.25 (2).
